(19) United States
(12) Patent Application Publication
(10) Pub. No.: US 2015/0294607 A1
(43) Pub. Date: Oct. 15, 2015

(54) HOUSING OF AN ACCESS CONTROL DEVICE FOR PEOPLE AND VEHICLES, A PARKING COLUMN OR A VENDING OR PAYMENT MACHINE FOR ACCESS AUTHORIZATION FOR PEOPLE AND MOTOR VEHICLES

(71) Applicant: SKIDATA AG, Groedig/Salzburg (AT)

(72) Inventors: GUIDO HARUCKSTEINER, Eugendorf (AT); Markus Leitner, Rohrdorf (DE)

(21) Appl. No.: 14/662,339

(22) Filed: Mar. 19, 2015

(30) Foreign Application Priority Data
Apr. 15, 2014 (DE) 20 2014 101 775.5

(51) Int. Cl. G09F 23/00; G07F 19/00; G07B 5/00; G07B 15/00; G09F 3/10; G09F 3/18

(52) U.S. Cl. CPC G09F 23/00; G09F 3/10; G09F 3/18; G07B 5/00; G07B 15/00; G07F 19/205; G09F 2023/0008; G09F 2003/023

(57) ABSTRACT

A housing for an access control device for people or motor vehicles, a parking column, a vending machine and/or a payment machine has at least one portion made of a transparent material. When the housing is in the assembled state, the inner side of the transparent portion or portions is provided with at least one of a paint coating, a foil and an adhesive label that, with the exception of the housing shape, are determinative features of the housing appearance.

### BACKGROUND OF THE INVENTION

The present invention relates to a housing of an access control device for people or motor vehicles and/or a parking column or a vending or payment machine for access authorization for people or motor vehicles.

Systems for access control for vehicles and people are known from the prior art. They typically comprise access control devices having a reading device for the access authorization, wherein for an effectively detected access authorization a blocking element is actuated in terms of opening to unblock the access. The blocking elements of the access control device for people can be designed as turnstiles, comprising one, two or more blocking arms, as flap gates, swing doors, folding doors, etc. With access control devices for motor vehicles, the blocking elements are typically designed as barrier gates or barrier gate pairs.

With access control devices for people, the blocking elements are mounted to a housing, in which typically are also arranged the electronics for operating the access control device as well as a reading device for preferably non-contact readout of the access authorization.

It is also known to provide parking consoles that are used to issue parking tickets when actuated by a vehicle driver. The consoles are located in front of entry driveways to parking garages. Such consoles are electronically coupled to operate parking barriers, opening them to grant access to a vehicle when a ticket is issued. With the prior art, a ticket must be read by a payment machine prior to leaving the parking garage, wherein payment takes place thereafter. Once the fee corresponding to a parking ticket is paid, the parking barrier is caused to open when the ticket is read by means of a reading device in the parking column assigned to that parking barrier.

With regard to appearance, the housings of such devices are typically adapted to the requirements of, and customized by, the respective parking operator. Information such as advertisements, logos and/or additional operator-specific data are applied to the housings, or parts of the housings, of the access control devices, to the parking columns, and to the vending or payment machines for access authorization for people and motor vehicles. The color design of the housing can correspond to the corporate identity of the operator for branding purposes. As a rule, the housings are composed of several housing parts.

As a rule, the appearance of the housing—except for its shape—arises from painting the surfaces of the housing that are visible in the assembled condition. In addition, information such as advertisements, logos, etc. that is to be displayed on the housings can also be applied by painting or by affixing respective adhesive labels.

However, this process inevitably results in damage, to a smaller or larger extent, to the paint coating or the adhesive labels during normal operation because the features that determine the appearance of the housing, except for its shape, are exposed to external influences. For example, the external surfaces of housings of access control devices for people in ski areas can be damaged or scratched by the skiing equipment of skiers as they pass through, which not only affects the originally attractive appearance but also results in poor readability of the information affixed to the housing.

This means, in turn, that the housing, or parts thereof, must be replaced or reworked frequently in order to ensure that the condition of the housing conforms to the requirements of the operators.

Furthermore, these housings, for example the housings of access control devices for people in ski areas, are often exposed to unfavorable weather conditions, which can also lead to damage of the housing's surface and, therefore, their appearance. In addition, the appearance of housings can be damaged by vandalism.

### SUMMARY OF THE INVENTION

It is therefore an objective of the present invention to provide a housing for an access control device for people or motor vehicles, a parking column or a vending or payment machine for access authorization for people or motor vehicles, wherein damage with regard to their appearance during normal operation is largely avoided. In furtherance of the invention, it is to be ensured that readability of information applied to the housing is not affected by damage during operation of the system. In addition, weather influences on the appearance of the housings and the readability of the information applied to the housings should be largely minimized.

These objectives, as well as further objectives that will become apparent from the discussion that follows are achieved, in accordance with the present invention, by proving a housing for an access control device for people or motor vehicles, a parking column, a vending machine and/or a payment machine, which has at least one portion thereof made of a transparent material. When the housing is in the assembled state, the inner side of the transparent portion or portions is provided with at least one of a paint coating, a foil and an adhesive label that, with the exception of the housing shape, are determinative features of the housing appearance.

Thus, a housing of an access control device for people or motor vehicles, a parking column or a vending or payment machine for access authorization for people and motor vehicles is proposed, in which at least a portion of the housing is made of a transparent material with the inner side in the assembled condition being provided with a paint coating, a foil, or with at least one adhesive label that contains the features determining the appearance. In this way the portion of the housing made of a transparent material, except for the shape, determines the appearance of the housing to a large extent. In this way, the coloration visible from the outside and the information that is seen from the outside may be customized and used for branding.

This arrangement ensures that the appearance of the at least one part of the housing that is made of a transparent material is protected from external influences, wherein the visibility of the color design and the information to be displayed is ensured by this transparent design. For example, the surfaces of the housings of access control devices for people in ski areas that are visible from the outside can be damaged through the ski equipment of skiers when passing the access control device, however, this does not affect the appearance of the housings.

Preferably, portion or portions of the housing that is made of a transparent material, namely, the housing or the housing parts that are made of a transparent material, are made of transparent plastic or Plexiglas. Furthermore, the portion(s) of the housing that is made of transparent material can be made of hardened glass or safety glass, preferably with high scratch resistance.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a side view of a personnel access control device (a turnstile) having a customized transparent housing panel in accordance with the present invention.

FIG. 2 is a detailed view of the transparent housing panel employed with the access control device of FIG. 1.

### DETAILED DESCRIPTION OF THE PREFERRED EMBODIMENTS

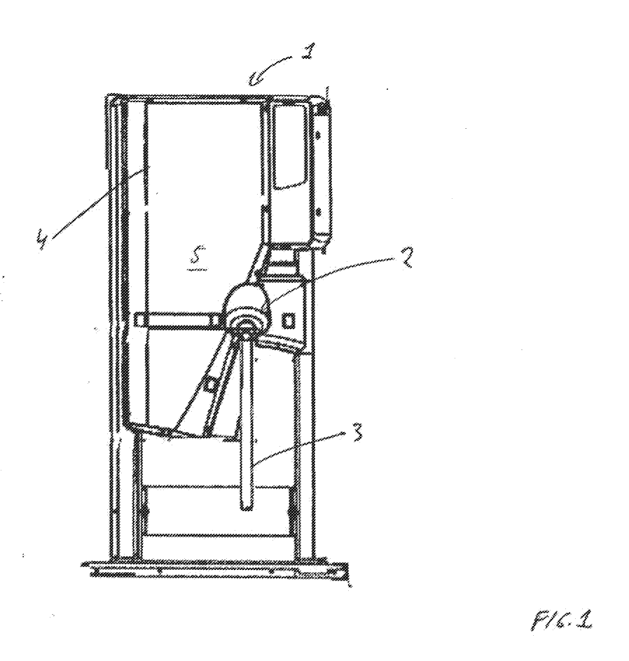

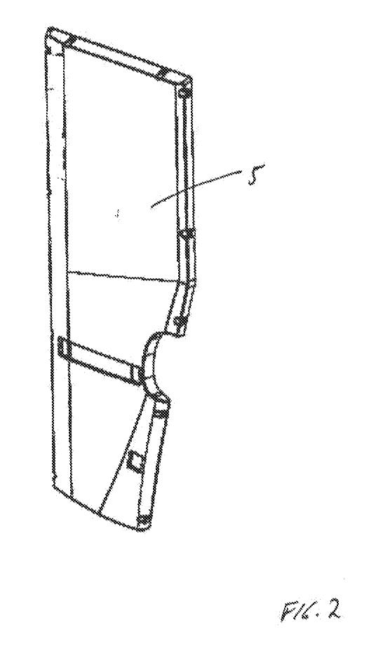

The preferred embodiments of the present invention will now be described with reference to FIGS. 1 and 2 of the drawings. Identical elements in the various figures are designated with the same reference numerals.

FIG. 1 shows an access control device 1 for people, having a turnstile 2 with three blocking arms 3 as the blocking element, wherein the turnstile is affixed to a housing 4 in which are arranged a reading device for access authorization to be obtained contact-free, and additional electronic and mechanical components for the operation of the device 1. The portion of the housing 4 that faces the people using the access control device 1 and that serves as the front cover is provided with the reference numeral 5 and is presented in perspective in FIG. 2.

As a rule, the portion 5 of the housing 4 of the access control device 1 that faces the people has a color design corresponding to the corporate identity of the operator, wherein information such as advertisements, logos and/or additional operator-specific data are applied and visible. The color design and the information directed at the people who use the access control device 1 are the features that determine the appearance of the housing 5, except for its shape.

To avoid damage to the appearance, except for the shape, of the housing portion 5 during operation, it is recommended, according to the invention, to make the portion 5 of the housing 4 of a transparent material, for example of transparent plastic or of Plexiglas, wherein the inner side of the housing 4 in the assembled condition is provided with a paint coating, a foil and/or with at least one adhesive label, which contain features that affect the appearance of the housing portion 5, except for the shape. In particular, the coloring visible from the outside and the information to be seen from the outside are applied to the inside of the transparent housing portion 5.

There has thus been shown and described a novel housing used in an access control system for people and/or motor vehicles, which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A housing for at least one of an access control device for people or motor vehicles, a parking column, a vending machine and a payment machine, said housing having at least one portion thereof made of a transparent material, and wherein the inner side of the at least one portion, when the housing is in the assembled state, is provided with at least one of a paint coating, a foil and an adhesive label that is visible through the transparent material and, with the exception of shape, are determinative features of the appearance of the housing.

2. The housing as defined in claim 1, wherein the at least one portion of the housing that is made of a transparent material is made of a material selected from the group consisting of transparent plastic, Plexiglas, hardened glass and safety glass.
